(19) United States
(12) Patent Application Publication
(10) Pub. No.: US 2012/0227602 A1
(43) Pub. Date: Sep. 13, 2012

(54) Cleaning Device for an Apparatus for Silk-Screen Printing on a Print Support

(75) Inventors: Christian Zorzi, Treviso (IT); Marco Gajotto, Dosson Di Casier (IT)

(73) Assignee: Applied Materials, Inc., Santa Clara, CA (US)

(21) Appl. No.: 13/395,570

(22) PCT Filed: Sep. 2, 2010
(86) PCT No.: PCT/EP2010/062844

§ 371 Date: May 29, 2012

(30) Foreign Application Priority Data
Sep. 16, 2009 (IT) US2009A000163

(51) Int. Cl. B41F 35/00

(52) U.S. Cl. 101/425

(57) ABSTRACT

Embodiments of the invention may provide a device for cleaning a silk-screen net of a silk-screen printing device. The silk-screen printing device may comprise a first shaft, a second shaft and a strip supported by the first shaft and the second shaft. The first shaft and the second shaft determine a movement of rotation of the strip along a determinate path, which is under the net, to remove the excess printing paste from the net. The strip is made of a non-elastic fabric material. The device also comprises a pressure roller of the rotary type, around part of which the strip is supported. The pressure roller is positioned along the path of the strip between the first shaft and the second shaft. The device also comprises a movement unit to move the pressure roller toward the net, to selectively take the strip into contact with the net with a desired pressure.

### CROSS-REFERENCE TO RELATED APPLICATIONS

This application claims benefit of International Patent Application Serial No. PCT/EP2010/062844 filed Sep. 2, 2010, which claims the benefit of Italian Patent Application Serial Number UD2009A000163, filed Sep. 16, 2009, which are both herein incorporated by reference.

### BACKGROUND OF THE INVENTION

### Field of the Invention

The present invention concerns a device used to clean components in an apparatus used to form one or more print tracks on a substrate, or print support. In one configuration, for example, the print tracks are formed using a silk-screen printing device to form conductive tracks on substrates used to form parts of electronic, photovoltaic or other similar devices.

It is known that to make conductive tracks on silicon-based wafers, in particular but not only for photovoltaic cells, the silk-screen printing technique is used, with suitable printing pastes.

Silk-screen printing provides to use brushes or blades by means of which, with a determinate pressure, the paste is spread on a suitable net, appropriately sized according to the desired development of the print tracks to be made.

Due to a non-optimum distribution, partial drying out and/or anomalies in the functioning of the feed circuit or the movement of the blades, the paste tends to be distributed in excess in some zones, or to form accumulations of paste which are reflected on the lower surface of the net, leading to a poorer quality of the print.

It is therefore necessary to periodically clean the nets, usually mechanically by means of scraping devices, using a brush, knife or scraper proper, which act under the net, eliminating the accumulations of paste.

To assist the mechanical cleaning and render it more effective, contrasting the drying out of the conductive paste, it is necessary to apply determinate solvent substances, usually volatile, on the scraper device, before or during scraping.

The use of solvents has the main disadvantage that it causes an at least partial pollution of the conductive paste which is printed, and hence a poorer quality of the print, since the solvent can migrate from the net to the printing paste.

In fact, no matter how carefully the quantity of solvent applied is dosed, and even though devices are provided to dry the solvent, a part of it will always go into contact with the paste that is used for printing.

Furthermore, to distribute the solvent it is necessary to provide suitable solvent containers, pressurized distribution circuits and relative controls to control the functioning parameters of the distribution line.

The international application WO-A-2009/053782 is known, which describes a cleaning device provided with a rotary strip of paper with a layer of adhesive that contacts the lower surface of the net in order to clean it, instead of the technique of cleaning with scraping and solvent. The strip of paper is fed from a feed roller, recovered and wound by a rewinding roller and, between the two rollers, a scraper element may be provided that takes the cleaning paper into cooperation with the lower surface of the net with a determinate contact pressure.

Purpose of the present invention is to achieve a cleaning device for an apparatus for the silk-screen printing of one or more print tracks on print supports by means of a print material, in particular for cleaning excess or accumulated print material from the net used in silk-screen printing, which prevents pollution by the cleaning solvent of the print material and which, at the same time, is effective and easy and economical to make.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

In accordance with the above purpose, a cleaning device according to the present invention is used to clean the silk-screen net, typically its lower surface, of an apparatus for the silk-screen printing of one or more print tracks on substrates by means of a print material, to give a non-restrictive example, to make conductive tracks printed on silicon-based wafers in order to make photovoltaic cells.

According to the present invention, the cleaning device comprises a first shaft, a second shaft and a strip able to clean the net and supported by the first shaft and the second shaft. The first shaft and the second shaft are able to determine a rotary movement, advantageously unwinding/winding, of the strip along a determinate path, typically under the net, in order to remove the excess printing paste from the net.

According to one form of embodiment, both the first shaft and the second shaft are motorized, advantageously in synchrony, with the advantage of allowing a complete control of the speed of rotation of the strip, both upstream and downstream along the path of the strip.

Alternatively, it may be provided that only the first shaft is motorized, to recover the strip, whereas the second shaft is idle, or free to rotate, due to friction, just as the opposite may also be provided.

The strip may be wound following a closed ring path between the first and second shaft.

Alternatively, the strip may develop following an open ring path between the second shaft and the first shaft. In this case, according to a specific form of embodiment, the second shaft, rotatable idle or commanded, is able to feed the strip, whereas the first shaft, rotatable in a commanded manner, is able to rewind it and recover it.

According to an aspect of the present invention, the strip is made of a non-elastic or inelastic fabric material. The embodiment with the non-elastic fabric is advantageous, since the strip thus configured is not extendible and guarantees an optimum constancy in use, both because the same quantity of fabric always rests on the net, and also because the substantial absence of deformations, elongations or contractions guarantees a uniform amplitude or width of the zone that is cleaned. Furthermore, thanks to the non-deformability of the fabric we have a constant speed of the fabric that interacts with the net, and therefore a constant contact surface.

There is another advantage when it is necessary to accelerate or decelerate the speed of rotation of the fabric strip which, not being elastic, finds an immediate and equal correspondence in the speed of the strip.

According to the present invention, moreover, the cleaning device comprises a rotary type pressure roller, around part of which the strip is supported, so that the strip finds itself between the pressure roller and the net above. The pressure roller is positioned along the path of the strip between the first shaft and the second shaft.

Furthermore, the cleaning device comprises a movement unit able to move the pressure roller toward said net, to selectively take the strip into contact with the net with a determinate contact pressure consistent with the cleaning operation to be carried out.

The embodiment with the rotary pressure roller allows a calibrated pressure on the net, without chafing, and therefore reduces friction on the net. It also determines a uniform and regular consumption of the fabric employed, that is, a reduced wear of the fabric, thus extending the operating life of the net above. The rotation and the cylindrical geometry itself of the external surface of the pressure roller optimize the power needed to move the cleaning strip, reducing energy consumption.

Moreover, the combination of the pressure roller, rotary and mobile toward the net, with the use of the inelastic fabric as above, is advantageous inasmuch as it allows to make the cleaning action on the net uniform, also preventing slippage, deformations or undesired tensions of the fabric.

According to one embodiment of the present invention, the fabric which makes up the strip is made of a mesh of first nylon-based threads, each of said threads being wound in a spiral by second polyester-based threads. This has the advantage that the fabric does not release fibers, threads, hairs or other, and is therefore optimum for the specific application of silk-screen printing of conductive tracks on wafers which, typically, requires all contamination to be avoided. Moreover, the fabric according to this embodiment meets the desired requirements of non-elasticity. Furthermore, the resultant fabric is not abrasive in its action of cleaning the net.

According to the present invention, thanks to the action of said movement unit, the pressure roller has at least a first operating condition, in which the strip is in contact with the net in order to clean it, and a second inactive condition, in which the strip is detached from the net.

Advantageously, the pressure roller is at least partly made of elastic or elastic-yielding material, such as rubber or foam rubber, in order to cushion or compensate the contact of the fabric on the net. Moreover, the deformation of the pressure roller, according to the force of contact, can also vary, depending on needs, the surface used for cleaning in contact with the net.

Furthermore, the rubber material of the pressure roller can advantageously determine a desired friction with the fabric, to prevent slippage thereof during rotation.

According to a variant, the pressure roller is at least partly covered by a different material, for example paper, able to absorb the excess print paste or solvent normally contained therein.

According to a variant embodiment, the pressure roller is mounted rotatable idly with respect to its longitudinal axis, being made to rotate due to friction of the strip. In this case, the pressure roller can follow the rotational movement imposed on the strip by the first and/or second shaft.

Alternatively, the pressure roller is mounted rotatable in a commanded manner with respect to its longitudinal axis, for example by means of its own autonomous motor means, advantageously synchronized with the drive of the first and second shaft.

The first and second shaft and the pressure roller are mounted on a slider under the net.

The slider can be moved parallel to the plane on which the net lies, at least in a direction transverse, advantageously orthogonal, to the action of the blade, to make the cleaning action on the whole lower surface of the net. The pressure roller with the relative cleaning strip not only has a movement from and toward the net, typically in a vertical direction with respect to the net which is normally positioned horizontal, but also assumes a movement of horizontal translation under the net, given by the transverse translation of said slider. In this way, the slider can be removed from the printing apparatus for the purposes of controlling and maintaining the cleaning strip or other accessories.

Moreover, to satisfy specific requirements, the slider can be made translatable also in the direction of action of the blade.

The pressure roller can be rotated on itself in a direction concordant with the movement of horizontal translation with respect to the net above. Alternatively, the pressure roller can be rotated in a discordant direction. The choice of one or the other direction of rotation can be advantageous to determine a more energetic cleaning action (discordant rotation) or less energetic (concordant rotation) on the net.

According to one form of embodiment, the pressure roller and the second shaft are positioned one next to the other, under the net, so that the plane tangent to the external surface both of the pressure roller and also of the second shaft is substantially parallel, or slightly inclined, with respect to the plane on which the net lies. This allows to position the fabric strip in a planar condition advantageous for the purposes of determining an extended cleaning surface on the net, and not only point-by-point. In particular, a slight inclination of the cleaning plane thus defined with respect to the plane on which the net lies advantageously creates a free lead-in area for the net which is progressively brought into contact with the strip supported by the pressure roller, obtaining a less rough cleaning action, and therefore safer.

According to a specific case of said variant, in which the pressure roller and the second shaft have substantially equivalent diameters, the pressure roller and the second shaft have their respective longitudinal axes aligned parallel to each other and lying on a plane substantially parallel, or slightly inclined, with respect to the plane on which the net above lies.

A variant solution provides that the first shaft is positioned below the pressure roller. In this way we obtain a triangular configuration of the two shafts and the pressure roller, which optimizes the movement of the strip and reduces bulk.

Another variant provides that the longitudinal axis of the first shaft and the longitudinal axis of the pressure roller are aligned, that is, they lie on a transverse plane, for example substantially perpendicular or slightly inclined, with respect to the plane on which the net lies.

According to another variant form, the movement unit is provided with adjustable-type actuation so as to be able to define, on each occasion, the pressure of contact of the pressure roller against the net, according to needs.

Advantageously, the cleaning device comprises actuation means able to be associated with the net and able to move the net toward the pressure roller. Consequently, since the net is mobile in height, it can approach the pressure roller below it, so as to cooperate with the reciprocal movement as the pressure roller approaches the net, for the cleaning action.

In combination with this, the present invention also comprises a sensitive member able to detect, and transmit a correlated signal, a determinate limit position of the net with respect to the pressure roller in the course of the movement of reciprocal approach of the net and pressure roller. This promotes the definition of the suitable cleaning force on the net, advantageously also according to the degree of elasticity of the net that is used.

Another advantage of the solution according to the present invention is that it provides data that can possibly be memorized in a system controller, in order to control and regulate, according to said data, the subsequent operating steps and/or subsequent operating cycles.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a schematic isometric view of a processing system that can be used with the device according to one embodiment of the present invention.

FIG. 2 is a schematic plan view of the system depicted in FIG. 1;

FIG. 3 is a perspective view of a cleaning device according to the present invention;

FIG. 4 is a front view of a cleaning device according to the present invention associated with a net for silk-screen printing and a relative printing blade;

FIG. 5 is a plan view from above of a cleaning device according to the present invention associated with a relative printing blade;

FIG. 6 is a lateral view of a cleaning device according to the present invention associated with a relative printing blade.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

With reference to the attached drawings, a cleaning device 10 according to the present invention is mounted below a silk-screen net, or screen printing mask, 12 of a processing, or printing, head 102 of an apparatus 100 for the silk-screen printing of conductive tracks on a substrate, such as a silicon-based wafer used to form photovoltaic cells.

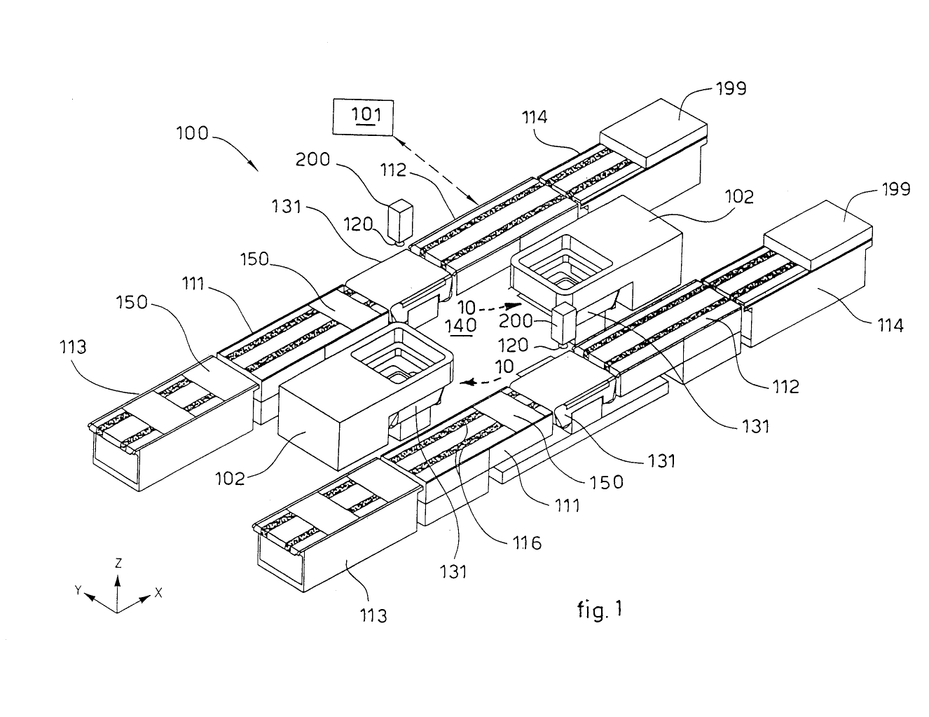

FIG. 1 is a schematic isometric view of a substrate processing apparatus, or system 100, that can be used in connection with embodiments of the present invention. In one embodiment, the system 100 generally includes two incoming conveyors 111, an actuator assembly 140, a plurality of processing nests 131, a plurality of processing heads 102, two outgoing conveyors 112, and a system controller 101. The incoming conveyors 111 are configured in a parallel processing configuration so that each can receive unprocessed substrates 150 from an input device, such as an input conveyor 113, and transfer each unprocessed substrate 150 to a processing nest 131 coupled to the actuator assembly 140. Additionally, the outgoing conveyors 112 are configured in parallel so that each can receive a processed substrate 150 from a processing nest 131 and transfer each processed substrate 150 to a substrate removal device, such as an exit conveyor 114. In one embodiment, each exit conveyor 114 is adapted to transport processed substrates 150 through an oven 199 to cure material deposited on the substrate 150 via the processing heads 102.

In one embodiment, substrates 150 are microcrystalline silicon substrates used for processing solar cells thereon. In another embodiment, substrates 150 are green tape ceramic substrates or the like.

In one embodiment of the present invention, the system 100 is a screen printing processing system and the processing heads 102 include screen printing components, which are configured to screen print a patterned layer of material on a substrate 150. In another embodiment, the system 100 is an ink jet printing system and the processing heads 102 include ink jet printing components, which are configured to deposit a patterned layer of material on a substrate 150. In yet another embodiment, the system 100 is a processing system that includes material removal components in the processing head 102, such as a laser for ablating or etching one or more regions of a substrate 150. In other embodiments, the system 100 may comprise other substrate processing modules requiring precise movement and positioning of the substrates for processing.

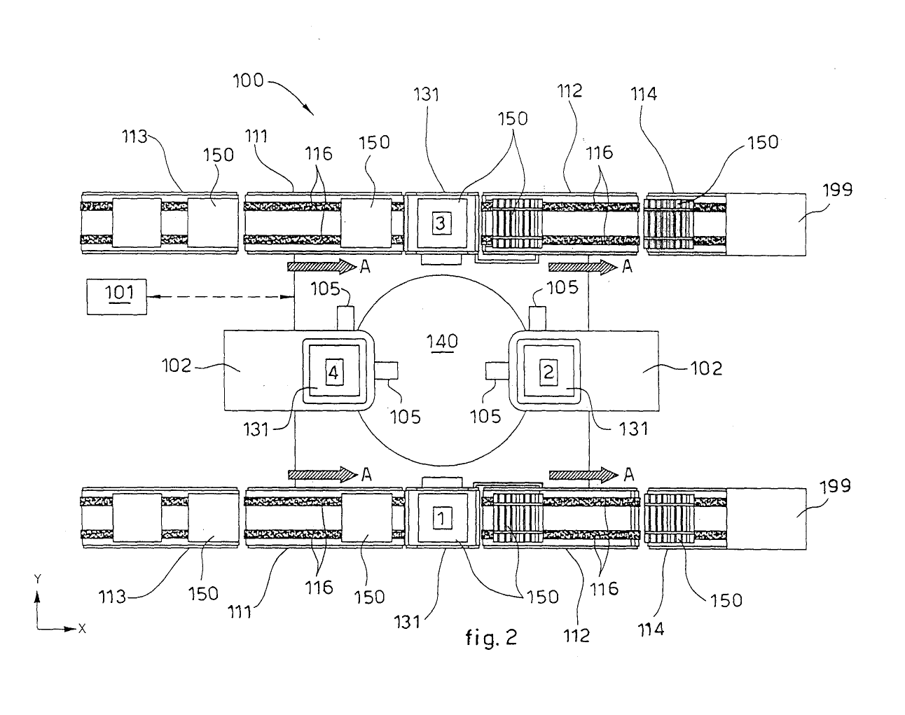

FIG. 2 is a schematic plan view of the system 100 depicted in FIG. 1. FIGS. 1 and 2 illustrate the system 100 having two processing nests 131 (in positions “1” and “3”) each positioned to both transfer a processed substrate 150 to the outgoing conveyor 112 and receive an unprocessed substrate 150 from the incoming conveyor 111. Thus, in the system 100, the substrate motion generally follows the path “A” shown in FIGS. 1 and 2. In this configuration, the other two processing nests 131 (in positions “2” and “4”) are each positioned under a processing head 102 so that a process (e.g., screen printing, ink jet printing, material removal) can be performed on the unprocessed substrates 150 situated on the respective processing nests 131. Such a parallel processing configuration allows increased processing capacity with a minimized processing system footprint. Although, the system 100 is depicted having two processing heads 102 and four processing nests 131, the system 100 may comprise additional processing heads 102 and/or processing nests 131 without departing from the scope of the present invention.

In one embodiment, the incoming conveyor 111 and outgoing conveyor 112 include at least one belt 116 to support and transport the substrates 150 to a desired position within the system 100 by use of an actuator (not shown) that is in communication with the system controller 101. While FIGS. 1 and 2 generally illustrate a two belt style substrate transferring system, other types of transferring mechanisms may be used to perform the same substrate transferring and positioning functions without varying from the basic scope of the invention.

In one embodiment, the system 100 also includes an inspection system 200, which is adapted to locate and inspect the substrates 150 before and after processing has been performed. The inspection system 200 may include one or more cameras 120 that are positioned to inspect a substrate 150 positioned in the loading/unloading positions “1” and “3,” as shown in FIGS. 1 and 2. The inspection system 200 generally includes at least one camera 120 (e.g., CCD camera) and other electronic components that are able to locate, inspect, and communicate the results to the system controller 101. In one embodiment, the inspection system 200 locates the position of certain features of an incoming substrate 150 and communicates the inspection results to the system controller 101 for analysis of the orientation and position of the substrate 150 to assist in the precise positioning of the substrate 150 under a processing head 102 prior to processing the substrate 150. In one embodiment, the inspection system 200 inspects the substrates 150 so that damaged or mis-processed substrates can be removed from the production line. In one embodiment, the processing nests 131 may each contain a lamp, or other similar optical radiation device, to illuminate the substrate 150 positioned thereon so that it can be more easily inspected by the inspection system 200.

The system controller 101, shown schematically in the drawings, facilitates the control and automation of the overall device 10 and may include a central processing unit (CPU) (not shown), memory (not shown), and support circuits (or I/O) (not shown). The CPU may be one of any form of computer processors that are used in industrial settings for controlling various chamber processes and hardware (e.g., conveyors, detectors, motors, fluid delivery hardware, etc.) and monitor the system and chamber processes (e.g., substrate position, process time, detector signal, etc.). The memory is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like.

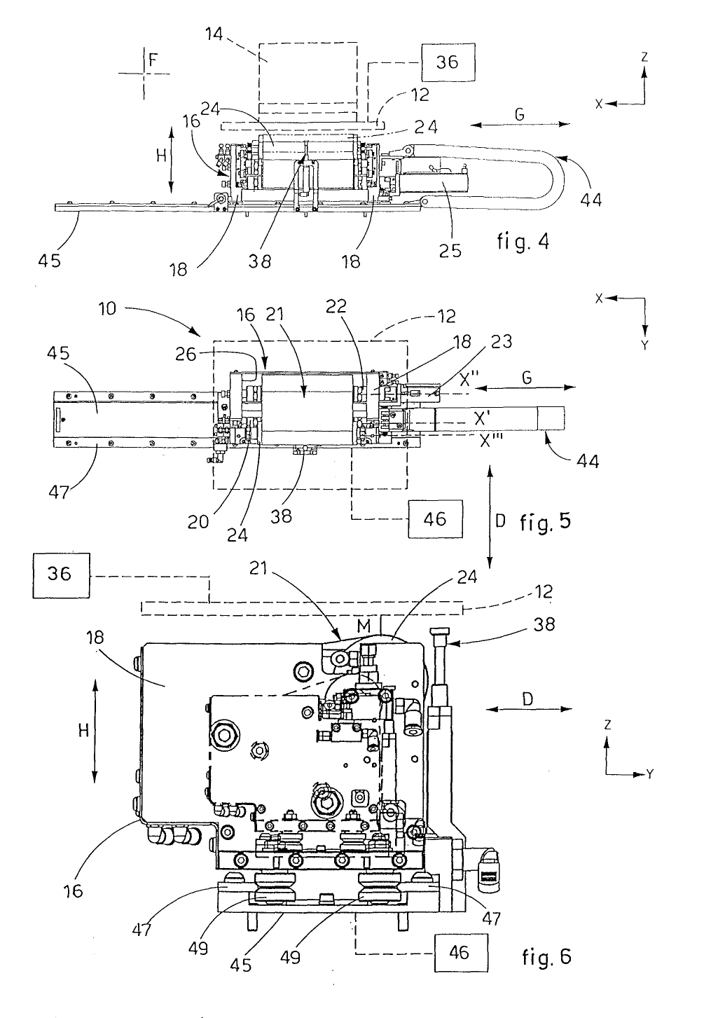

In one embodiment, the two processing heads 102 utilized in the system 100 may be conventional screen printing heads available from Applied Materials Italia Srl which are adapted to deposit material in a desired pattern on the surface of a substrate 150 disposed on a processing nest 131 in position “2” or “4” during a screen printing process. In one embodiment, the processing head 102 includes a plurality of actuators, for example, actuators 105 (e.g., stepper motors or servomotors) that are in communication with the system controller 101 and are used to adjust the position and/or angular orientation of a screen printing mask (not shown) disposed within the processing head 102 with respect to the substrate 150 being printed. In one embodiment, the screen printing mask is a metal sheet or plate with a plurality of holes, slots, or other apertures formed therethrough to define a pattern and placement of screen printed material on a surface of a substrate 150. In one embodiment, the screen printed material may comprise a conductive ink or paste, a dielectric ink or paste, a dopant gel, an etch gel, one or more mask materials, or other conductive or dielectric materials. In general, the screen printed pattern that is to be deposited on the surface of a substrate 150 is aligned to the substrate 150 in an automated fashion by orienting the screen printing mask using the actuators 105 and information received by the system controller 101 from the inspection system 200. In one embodiment, the processing heads 102 are adapted to deposit a metal containing or dielectric containing material on a solar cell substrate having a width between about 125 mm and 156 mm and a length between about 70 mm and 156 mm. Normally, in the case of silk-screen printing process, in the processing heads 102 a printing blade 14 acts above the net 12, in a first direction indicated by arrow “F”, for convenience shown only schematically in FIG. 4, to spread and print the conductive paste. The first direction of arrow “F” lies on a plane parallel to the plane on which the net 12 lies. The device 10 comprises a supporting slider 16, which has lateral walls 18 which delimit an internal housing seating 26.

Inside the housing seating 26 a first rewinding shaft 20 and a second feed shaft 22 are mounted, rotatably mounted on the lateral walls 18, and both motorized independently in order to control the rotation of a cleaning strip 21, made of fabric, associated with them.

The first rewinding shaft 20 and the second feed shaft are able to control the rotary movement, advantageously unwinding/winding the cleaning strip 21 along a determinate path, typically under the net 12, in order to remove the excess printing paste from the net 12.

In particular, on one lateral wall 18, outside the housing seating 26, a first motor 23 (FIG. 5) and a second motor 25 (FIG. 4) are mounted, which drive in rotation respectively the first shaft 20 and the second shaft 22.

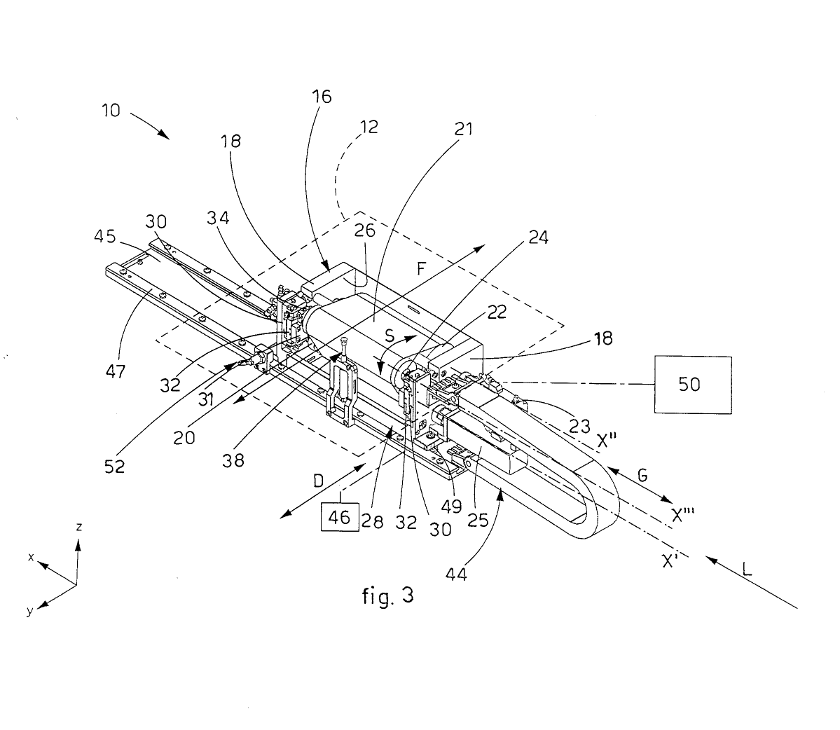

The strip 21 is thus made to rotate along said determinate path, as indicated by the arrow “S” in FIG. 3, between the first shaft 20 and the second shaft 22, under the net 12.

According to an embodiment of the invention, said path is a closed ring path, so that the strip 21 may be wound following said closed ring path between the first shaft 20 and second shaft 22.

Alternatively, the strip 21 may develop following an open ring path between the second shaft 22 and the first shaft 20. In this case, according to a specific form of embodiment, the second shaft 22, rotatable idle or commanded, is able to feed the strip 21, whereas the first shaft 20, rotatable in a commanded manner, is able to rewind it and recover it.

According to the present invention, the strip 21 of elastic or non-elastic materials may be used. In one example, a relatively non-elastic, or inelastic, fabric material is used.

In particular, the non-elastic fabric material used according to the present invention is generally non-extendible and has a minimum elastic deformation given an applied stress, advantageously when subjected to tangential deformations or traction.

Advantageously, the fabric that makes up the strip 21 is made of a nylon mesh with threads wound in a spiral from polyester-based threads. For example, the fabric used can be found on the market under the name of MiraWIPE®.

The use of the fabric strip 21 allows to clean the net without using solvents, and therefore prevents the solvents damaging the paste present at the back of the net.

Moreover, the embodiment with the non-elastic material is advantageous, since the strip 21 thus configured is not extendible and guarantees an optimum constancy in use, both because the same quantity of fabric always rests on the net 12, and also because the substantial absence of deformations, elongations or contractions guarantees a uniform amplitude or width of the zone that is cleaned. Furthermore, thanks to the non-deformability of the fabric we have a constant speed of the fabric that interacts with the net 12, and therefore a constant contact surface.

The embodiment with the non-elastic material is also advantageous when it is necessary to accelerate or decelerate the speed of rotation of the fabric strip 21 which, not being elastic, finds an immediate and equal correspondence in the speed of the rotating shafts 20, 22.

According to one embodiment of the present invention, the fabric which makes up the strip 21 is made of a mesh of first nylon-based threads, each of said threads being wound in a spiral by second polyester-based threads. This has the advantage that the fabric does not release fibers, threads, hairs or other, and is therefore optimum for the specific application of silk-screen printing of conductive tracks on wafers which, typically, requires all contamination to be avoided. Moreover, the fabric according to this embodiment meets the desired requirements of non-elasticity. Furthermore, the resultant fabric is not abrasive in its action of cleaning the net.

The cleaning device 10 that uses a fabric strip 21 is effective, for example, in cases when the conductive paste to be cleaned is particularly hard or abrasive and tenacious giving a strong bond to the surface. In this case, it is possible to make a “false” silk-screen printing, able only to dampen the net 12 and, with the solvent normally present in the freshly delivered conductive paste, to encourage the softening of the incrustations of paste and promote the mechanical cleaning action by the strip 21.

The rotation of the first shaft 20 and the second shaft 22 determines the overall rotation of the strip 21 for the consequent mechanical cleaning action of the net 12, as indicated by the arrow “S” in FIG. 3.

Consequently, the strip 21, seen locally in proximity with the surface of the net 12 (FIGS. 4 and 6), rotates generally in a direction opposite that of the horizontal movement of the net 12. As explained hereafter in the description, the strip 21 and the net 12 are also reciprocally brought near each other, to a determinate point of contact, after which the strip 21 is made to rotate.

Furthermore, the cleaning device 10 also comprises a rotary pressure roller 24, which is disposed intermediate between the first shaft 20 and the second shaft 22, along the path of the strip 21, and rotatably supports the strip 21, which travels tangentially over its external surface, in order to bring it into contact with the lower surface of the net 12 to clean it mechanically.

In particular, the pressure roller 24 is able to rotate on itself, around its own longitudinal axis of rotation X′″ (FIG. 5).

According to a variant, the pressure roller 24 is free to rotate idly, and follows, due to friction, the movement of the strip 21 imposed by the first shaft 20 and/or the second shaft 22.

Another variant provides that the pressure roller 24 rotates in a commanded manner by means of motor means (not shown), for example stepper motors or servomotors, advantageously synchronized with the drive of the two shafts 20, 22. This has the advantage of allowing a complete control of the speed of rotation of the strip 21, both upstream and downstream along the path of the strip 21. Said syncronization could be achieved, for example, by means of said system controller 101.

According to another embodiment of the invention, first shaft 20 is motorized, to recover the strip 21, whereas the second shaft 22 is idle, or free to rotate, due to friction, just as the opposite may also be provided.

Moreover, the pressure roller 24 is able to be selectively lifted and lowered, for example by use of said system controller 101, so as to take the strip 21 into contact with the net 12, as indicated by the arrow “M” in FIG. 6.

In this way, the pressure roller 24 has at least a first operating condition, in contact with the net 12, and a second inactive condition, detached from the net 12, as can be seen in FIG. 4, where the pressure roller 24 is shown with a continuous line in the inactive condition and with dashes in the operating condition.

The pressure roller 24, suitably driven upward, that is, toward the net 12, thrusts the strip 21 into contact with the lower surface of the net 12, to carry out the mechanical cleaning. The entity of the pressure exerted by the pressure roller 24 can be modulated by using said system controller 101, for example according to cleaning requirements or the characteristics of the conductive paste and/or the net 12.

The pressure roller 24 can be rotated on itself in a direction concordant with the movement of horizontal translation with respect to the net 12 above. Alternatively, the pressure roller 24 can be rotated in a discordant direction. The choice of one or the other direction of rotation can be advantageous to determine a more energetic cleaning action (discordant rotation) or less energetic (concordant rotation) on the net 12.

The embodiment with the rotary pressure roller 24 determines a uniform and regular consumption of the fabric employed, that is, a reduced wear of the fabric, thus extending the operating life of the net 12 above. The rotation and the cylindrical geometry itself of the external surface of the pressure roller 24 optimize the power needed to move the cleaning strip, reducing energy consumption.

The combination of the pressure roller 24, rotary and mobile toward the net 12, with the use of the inelastic fabric as above, is advantageous inasmuch as it allows to make the cleaning action on the net 12 uniform, also preventing slippage, deformations or undesired tensions of the fabric.

In some embodiments of the present invention, the pressure roller 24 is at least partly covered by a different material, for example paper, able to absorb the excess print paste or solvent normally contained therein.

The vertical movement of approach and distancing of the pressure roller 24 with respect to the net 12 is determined by a suitable movement unit 28.

According to one form of embodiment, the movement unit 28 comprises two guide elements 30, located inside the housing seating 26 on both lateral walls 18, in a position mating with the two ends of the rotation shaft of the pressure roller 24. Inside the two guide elements 30 sliding blocks 32 are housed slidingly. Each sliding block 32 is connected to a relative slider 31, which in turn is attached to the ends of the shaft of the pressure roller 24, to determine the translation thereof. To this purpose, to move each relative slider 31, a linear actuator 34 is provided, which thus determines the lifting or lowering of the pressure roller 24, as required. Advantageously, the action of the linear actuator 34 is of the adjustable type, to calibrate the pressure of contact on the net 12.

According to the present invention, thanks to the action of said movement unit 28, the pressure roller 24 is provided with said first operating condition, in which the strip 21 is in contact with the net 12 in order to clean it, and with said second inactive condition, in which the strip 21 is detached from the net 12.

The system controller 101 synchronizes the movement of the pressure roller 24 with the various printing steps and the subsequent cleaning, commanding the relative linear actuators 34.

It is clear that, to move the pressure roller 24 upward, a variant according to the present invention can provide a single guide element 30 on one side of the housing seating 26 with a relative sliding block 32, relative slider 31 and linear actuator 34.

Given the delicate role of the strip 21 of thrusting upward, the pressure roller 24 is advantageously made, at least partly, of a soft material, such as rubber or foam rubber. This allows to compensate and/or cushion the contact between net 12 and strip 21.

According to one form of embodiment, the device 10 comprises actuation means 36 (for convenience shown schematically only in FIGS. 4 and 6), which are able to determine a linear movement, up and down and vice versa, of the net 12 with respect to the strip 21 below, as indicated by the arrow “H”.

In some embodiments, actuation means 36 are configured the same as the actuators 105 described in FIG. 2.

Consequently, the possibility of moving the net 12 in height promotes the cooperation between the net 12 and the strip 21 in the course of the cleaning step. The actuation means 36 are controllable in their drive, advantageously by the same system controller 101, to determine a desired contact pressure, more or less strong, of the net 12 and the strip 21. The pressure of the net 12 on the strip 21 is determined according to the desired type of cleaning to be carried out, more or less intense.

According to one form of embodiment, the device 10 comprises a sensitive element, or sensor, able to detect the position of the net 12 with respect to the pressure roller 24 below, in the course of the reciprocal movement of approach.

In some embodiments, the sensitive element can be a pressure-sensitive element connected to a load cell or other device suitable for determining pressure. Therefore, the sensitive element can be used to define also the pressure of the net 12 on the strip 21. The signals from the sensitive element can be processed by the system controller 101 to control the actuation means 36 to determine said contact pressure of the net 12 on the strip 21.

The sensitive element comprises, according to a variant, a feeler pin 38 (FIGS. 5 and 6) or other member to detect pressure, which is positioned under the net 12 and extends upward by a determinate height. The height is correlated to the desired distance between the net 12 and strip 21 below, during cleaning. In the solution given as an example in the attached drawings, the feeler pin 38 is disposed vertical, in a median position along the shafts 20, 22 and the pressure roller 24, between the two lateral walls 18.

The signals relating to contact and pressure detected by the sensitive element, in this case by the feeler pin 38, are transmitted to said system controller 101.

When the net 12 approaches the strip 21 to promote cleaning, the upper end of the feeler pin 38 interferes with the lower surface of the net 12. Consequently, a relative signal is generated that the feeler pin 38 transmits to the system controller 101 which, consequently, commands the movement of the net 12 toward the strip 21 to stop. The feeler pin 38 thus functions as an element to signal the end-of-travel in the movement of reciprocal lifting and lowering of the net 12 and the strip 21.

Instead of the feeler pin 38 it can be provided to use one or more photoelectric cells as sensitive element to determine the position between the net 12 and the strip 21.

In some embodiments, the feeler pin 38, or other pressure-sensitive element, can be used in connection with the photoelectric cells to define both the contact pressure of the net 12 on the strip 21 and the reciprocal position of the net 12 and the strip 21.

According to a variant embodiment, the second shaft 22 and the pressure roller 24 have their relative axes of rotation X″ and X′″ lying on the same plane, whereas the first shaft 20 has its axis of rotation X′ lying below the planes on which the axes of rotation X″ and X′″ of said second shaft 22 and pressure roller 24 lie. The shafts 20, 22 and the pressure roller 24 also have their respective axes of rotation X′, X″, X′″ parallel to each other and transverse to the first direction of arrow “F”. In this case, the shafts 20, 22 and the pressure roller 24 are geometrically positioned according to a triangular spatial configuration, when seen laterally in the direction indicated by the arrow “L” in FIG. 3.

In some embodiments of the present invention, the pressure roller 24 and the second shaft 22 are positioned one next to the other, under the net 12, so that the plane tangent to the external surface both of the pressure roller 24 and also of the second shaft 22 is substantially parallel, or slightly inclined, with respect to the plane on which the net 12 lies. This allows to position the fabric strip 21 in a planar condition advantageous for the purposes of determining an extended cleaning surface on the net 12, and not only point-by-point. In particular, a slight inclination, determined by the roller stroke, for example to a maximum value of 20° and that can be regulated depending on customer product, of the cleaning plane thus defined with respect to the plane on which the net 12 lies advantageously creates a free lead-in area for the net 12 which is progressively brought into contact with the strip 21 supported by the pressure roller 24, obtaining a less rough cleaning action, and therefore safer.

According to one form of embodiment, the device 10 comprises first horizontal translation means 44 (for convenience shown schematically only in FIGS. 3, 4 and 5), by means of which the slider 16 is made translatable under the net 12, in the direction transverse to the action of the blade 14 represented by the arrow “F”, in order to bring the strip 21 into contact with the whole of the lower surface of the net 12, in order to clean it.

In particular, thanks to the translation means 44, the slider 16 can be translated in a direction substantially orthogonal to the first direction of arrow “F” along which the printing blade 14 acts, as indicated by the arrow “G”. This also allows to remove the slider 16 and the cleaning device 10 from the printing head, for example for maintenance, refurbishment or replacement purposes. A piston 52 is mobile to selectively clamp, for example by inserting in a conjugated seat (not shown), the slider 16 in the working position under the net 12, or in the inactive position outside the bulk of the net 12. According to a variant, photocells may be provided which generate position signals that are processed by the system controller 101 in order to command the translation means 44 and control the actual position of the slider 16.

Advantageously, the device 10 comprises, according to another variant, second horizontal translation means 46, by means of which the slider 16 is also made translatable in a second direction “D”, parallel to the first direction of arrow “F” and also lying on a plane parallel to the plane on which the net 12 lies. In this case, the slider 16 is provided at the lower part with guide rollers 49 to slide along a support guide 47, in particular configured as a rail, installed on a supporting plate 45 located under the slider 16, which extends longitudinally in a direction transverse to the first working direction of arrow “F” of the printing blade 14.

In this way, the slider 16 can be removed from under the net 12, outside the printing head, for example to control the state of the strip 21 or in any case to be easily subjected to maintenance. In this way, the maintenance of the cleaning device 10 and the replacement of the strip 21 can be carried out even during the working of the plate elements for electronics, without interrupting the silk-screen printing operation and the production cycle.

Advantageously, the device 10 is activated automatically when an associated visual control system installed on the printing machine (see for example application WO-A-2009/053784) sees that the net is broken, or in any case detects a poor quality of the print. It is clear, however, that the device 10 can also be activated by force by an operator, any time he considers it necessary, even with pre-set temporal deadlines.

It is clear that modifications and/or additions of parts may be made to the cleaning device 10 for an apparatus for silk-screen printing on print supports as described heretofore, without departing from the field and scope of the present invention.

It is also clear that, although the present invention has been described with reference to specific examples, a person of skill in the art shall certainly be able to achieve many other equivalent forms of cleaning device for an apparatus for silk-screen printing on print supports, having the characteristics as set forth in the claims and hence all coming within the field of protection defined thereby.

1.-14. (canceled)

15. A cleaning device for cleaning a screen printing net of a screen printing apparatus, comprising:
a first shaft;
a second shaft;
a cleaning strip being disposed between the first shaft and the second shaft, the cleaning strip configured to remove a material from the screen printing net when the cleaning strip is disposed against at least a portion of the screen printing net;
a rotary pressure roller positioned between the first shaft and the second shaft, and configured to rotatably support at least a portion of the cleaning strip; and
a movement unit configured to position the rotary pressure roller relative to the screen printing net,
wherein the movement unit comprises a linear actuator that is configured to create a contact pressure between the cleaning strip and the screen printing net.

16. The cleaning device of claim 15, wherein the movement unit is configured to position the rotary pressure roller in a first operating position and a second operating position, wherein the rotary pressure roller is configured to cause the cleaning strip to contact the screen printing net when it is in the first operating position.

17. The cleaning device of claim 16, wherein the rotary pressure roller positioned at the second operating position is disposed a distance from the screen printing net so that the cleaning strip is not in contact the screen printing net.

18. The cleaning device of claim 16, wherein the rotary pressure roller is rotatable by use of an actuator.

19. The cleaning device of claim 15, wherein the rotary pressure roller comprises a material selected from the group consisting of an elastic material, an elastic-yielding material, rubber, and foam rubber.

20. The cleaning device of claim 15, wherein the rotary pressure roller is at least partly covered by a material comprising paper.

21. The cleaning device of claim 15, wherein the cleaning strip comprises a non-elastic fabric material.

22. The cleaning device of claim 15, wherein the cleaning strip comprises a mesh comprising nylon-based threads and polyester-based threads.

23. The cleaning device of claim 22, wherein each of the nylon-based threads are wound in a spiral around the polyester-based threads.

24. The cleaning device of claim 15, wherein the first shaft, the second shaft, and the rotary pressure roller are disposed on a slider that is configured to move the first shaft, second shaft and rotary pressure roller relative to the screen printing net.

25. The cleaning device of claim 15, further comprising a first plane that is tangent to an external surface of the rotary pressure roller and an external surface of the second shaft, wherein the first plane is substantially parallel to, or slightly inclined with, a second plane that is parallel to a surface of the screen printing net.

26. The cleaning device of claim 15, wherein the first shaft, the second shaft, and the rotary pressure roller are geometrically positioned in a triangular spatial configuration.

27. The cleaning device of claim 15, further comprising:
a first plane that is parallel to a surface of the screen printing net;
a longitudinal axis of the second shaft; and
a longitudinal axis of the rotary pressure roller,
wherein the longitudinal axis of the rotary pressure roller and the longitudinal axis of the second shaft are disposed on a second plane that is substantially parallel to, or slightly inclined to, the first plane.

28. The cleaning device of claim 15, further comprising:
a first plane that is parallel to a surface of the screen printing net;
a longitudinal axis of the first shaft; and
a longitudinal axis of the rotary pressure roller,
wherein the longitudinal axis of the first shaft and the longitudinal axis of the pressure roller are disposed on a second plane substantially perpendicular to, or slightly inclined to, the first plane.

29. The cleaning device of claim 15, further comprising:
an actuation mechanism coupled to the screen printing net and configured to position the screen printing net relative to the rotary pressure roller.

30. The cleaning device of claim 15, further comprising:
a sensor coupled to the screen printing net, and configured to sense the contact pressure created between the cleaning strip and the screen printing net.

31. The cleaning device of claim 30, wherein the sensor comprises a pressure-sensitive pin element that is in contact with the screening printing net.

32. The cleaning device of claim 31, wherein the pressure-sensitive pin element is configured to sense the contact pressure between the screen printing net on the cleaning strip while moving the screen printing net and the rotary pressure roller relative to each other by use of an actuation mechanism coupled to the screen printing net and/or the movement unit coupled to the rotary pressure roller.

33. An apparatus for depositing a material on a surface of a substrate, comprising:
a printing blade;
a screen printing net coupled to an actuation mechanism;
a cleaning device for cleaning the screen printing net of the screen printing apparatus, comprising:
a first shaft;
a second shaft;
a cleaning strip disposed between the first shaft and the second shaft, the cleaning strip configured to remove a printing paste material from the screen printing net when the cleaning strip is disposed against at least a portion of the screen printing net;
a rotary pressure roller positioned between the first shaft and the second shaft, and configured to rotatably support at least a portion of the cleaning strip; and
a movement unit configured to position the rotary pressure roller relative to the screen printing net,
wherein the movement unit comprises a linear actuator that is configured to create a contact pressure between the cleaning strip and the screen printing net.

34. The apparatus of claim 33, wherein a movement unit is configured to move the rotary pressure roller relative to the screen printing net.

35. The apparatus of claim 33, further comprising:
a pressure-sensitive feeler pin element positioned against the screen printing net, wherein the pressure-sensitive feeler pin is configured to measure a contact pressure when it is positioned against the screen printing net.
